(19) United States
(12) Patent Application Publication
(10) Pub. No.: US 2026/0186934 A1
(43) Pub. Date: Jul. 2, 2026

(54) SYSTEMS, METHODS, AND MEDIA FOR OPTIMIZING SOLID-STATE DRIVE PERFORMANCE

(71) Applicant: SK hynix NAND Product Solutions Corp., Rancho Cordova, CA (US)

(72) Inventors: Ravi Motwani, Fremont, CA (US); Declan Byrne, White Rock (CA); Kasturi Kiran Ghonsikar, Renton, WA (US); Mark Anthony Golez, Folsom, CA (US); Daniel McLeran, Loveland, CO (US); Sarvesh Varakabe Gangadhar, Milpitas, CA (US)

(21) Appl. No.: 19/006,990

(22) Filed: Dec. 31, 2024

(51) Int. Cl. G06F 11/263; G06F 11/22

(52) U.S. Cl. CPC G06F 11/263; G06F 11/2263

(57) ABSTRACT

Mechanisms for optimizing solid-state drive (SSD) performance are provided, the mechanisms including: determining a current workload type of an SSD; selecting SSD parameters to optimize based on the current workload type; setting current values of the SSD parameters; testing performance of the SSD using the current values of the SSD parameters; changing one or more of the current values of the SSD parameters; re-testing the performance of the SSD after changing the current values; and setting the current values of the SSD parameters to determined best values of the SSD parameters. In some of these embodiments, setting the current values of the SSD parameters comprises setting the current values to random values or pseudo-random values. In some of these embodiments, testing performance of the SSD using the current values of the SSD parameters is performed using a test workload.

### BACKGROUND

Solid-state drives (SSDs) are widely used in computing platforms to store programs and data. To configure themselves for a given workload, many SSDs look-up and set themselves to use predetermined parameter settings based on the given workload. However, such settings are frequently not optimal for the given workload due to the workload not perfectly matching those workload types for which predetermined parameter settings have been provided.

Accordingly, new mechanisms for optimizing solid-state drive performance are desirable.

### SUMMARY

In accordance with some embodiments, new mechanisms, including systems, methods, and media, for optimizing solid-state drive performance are provided.

In some embodiments, systems for optimizing solid-state drive (SSD) performance are provided, the systems comprising: memory; and at least one hardware processor coupled to the memory and collectively configured to at least: determine a current workload type of an SSD; select SSD parameters to optimize based on the current workload type; set current values of the SSD parameters; test performance of the SSD using the current values of the SSD parameters; change one or more of the current values of the SSD parameters; re-test the performance of the SSD after changing the current values; and set the current values of the SSD parameters to determined best values of the SSD parameters. In some of these embodiments, setting the current values of the SSD parameters comprises setting the current values to random values or pseudo-random values. In some of these embodiments, testing performance of the SSD using the current values of the SSD parameters is performed using a test workload. In some of these embodiments, changing one or more of the current values of the SSD parameters is based on an output of a reinforcement learning agent. In some of these embodiments, the output of the reinforcement learning agent is based on a reward function that is based on a measurement of input output operations performed by the SSD during the testing and measurements of an average power, a burst power, and a peak power used by the SSD during the testing. In some of these embodiments, changing one or more of the current values of the SSD parameters comprises incrementing or decrementing the current values. In some of these embodiments, changing one or more of the current values of the SSD parameters comprises changing the current values to random values or pseudo-random values.

In some embodiments, methods for optimizing solid-state drive (SSD) performance are provided, the methods comprising: determining a current workload type of an SSD using a hardware processor; selecting SSD parameters to optimize based on the current workload type; setting current values of the SSD parameters; testing performance of the SSD using the current values of the SSD parameters; changing one or more of the current values of the SSD parameters; re-testing the performance of the SSD after changing the current values; and setting the current values of the SSD parameters to determined best values of the SSD parameters. In some of these embodiments, setting the current values of the SSD parameters comprises setting the current values to random values or pseudo-random values. In some of these embodiments, testing performance of the SSD using the current values of the SSD parameters is performed using a test workload. In some of these embodiments, changing one or more of the current values of the SSD parameters is based on an output of a reinforcement learning agent. In some of these embodiments, the output of the reinforcement learning agent is based on a reward function that is based on a measurement of input output operations performed by the SSD during the testing and measurements of an average power, a burst power, and a peak power used by the SSD during the testing. In some of these embodiments, changing one or more of the current values of the SSD parameters comprises incrementing or decrementing the current values. In some of these embodiments, changing one or more of the current values of the SSD parameters comprises changing the current values to random values or pseudo-random values.

In some embodiments, non-transitory computer-readable medium containing computer executable instructions that, when executed by a processor, cause the processor to perform a method for optimizing solid-state drive (SSD) performance are provided, the method comprising: determining a current workload type of an SSD; selecting SSD parameters to optimize based on the current workload type; setting current values of the SSD parameters; testing performance of the SSD using the current values of the SSD parameters; changing one or more of the current values of the SSD parameters; re-testing the performance of the SSD after changing the current values; and setting the current values of the SSD parameters to determined best values of the SSD parameters. In some of these embodiments, setting the current values of the SSD parameters comprises setting the current values to random values or pseudo-random values. In some of these embodiments, testing performance of the SSD using the current values of the SSD parameters is performed using a test workload. In some of these embodiments, changing one or more of the current values of the SSD parameters is based on an output of a reinforcement learning agent. In some of these embodiments, the output of the reinforcement learning agent is based on a reward function that is based on a measurement of input output operations performed by the SSD during the testing and measurements of an average power, a burst power, and a peak power used by the SSD during the testing. In some of these embodiments, changing one or more of the current values of the SSD parameters comprises incrementing or decrementing the current values. In some of these embodiments, changing one or more of the current values of the SSD parameters comprises changing the current values to random values or pseudo-random values.

### BRIEF DESCRIPTION OF THE DRAWINGS

FIG. 1 is a block diagram of an example solid-state drive (SSD) in accordance with some embodiments.

FIG. 2 is a flow diagram of an example process for controlling optimization of SSD parameters in accordance with some embodiments.

FIG. 3 is a flow diagram of an example process for optimizing SSD parameters using reinforcement learning in accordance with some embodiments.

FIG. 4 is a flow diagram of an example process for optimizing SSD parameters using a parameter sweep technique in accordance with some embodiments.

FIG. 5 is a flow diagram of an example process for optimizing SSD parameters using a Monte Carlo technique in accordance with some embodiments.

FIGS. 6A and 6B are flow diagrams of example processes that can be used for training a machine learning classifier to determine workload types in accordance with some embodiments.

FIG. 7 is a flow diagram of an example process for using a machine learning classifier to determine workload types in accordance with some embodiments.

### DETAILED DESCRIPTION

In accordance with some embodiments, new mechanisms, including systems, methods, and media, for optimizing solid-state drive (SSD) performance are provided.

In some of these embodiments, SSD parameters can be configured using reinforcement learning, parameter sweep techniques, and/or Monte Carlo techniques.

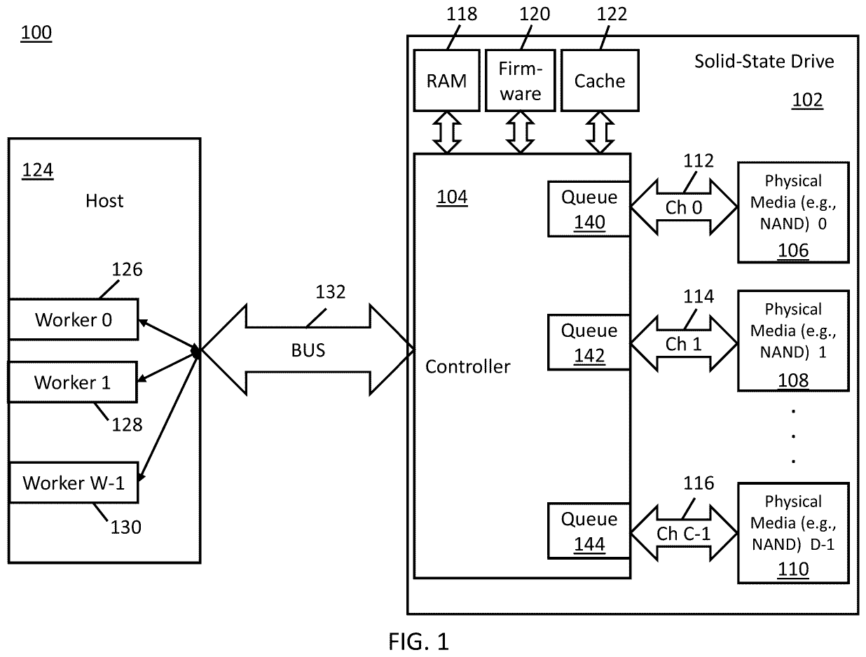

Turning to FIG. 1, an example block diagram of a solid-state drive 102 coupled to a host device 124 via a bus 132 in accordance with some embodiments is illustrated.

As shown, solid-state drive 102 can include a controller 104, physical media (e.g., NAND devices) 106, 108, and 110, channels 112, 114, and 116, random access memory (RAM) 118, firmware 120, and cache 122 in some embodiments. In some embodiments, more or fewer components than shown in FIG. 1 can be included. In some embodiments, two or more components shown in FIG. 1 can be included in one component.

Controller 104 can be any suitable controller for a solid-state drive in some embodiments. In some embodiments, controller 104 can include any suitable hardware processor(s) (such as a microprocessor, a digital signal processor, a microcontroller, a programmable gate array, etc.). In some embodiments, controller 104 can also include any suitable memory (such as RAM, firmware, cache, buffers, latches, etc.), interface controller(s), interface logic, drivers, etc. In some embodiments, controller 104 can be coupled to, or include (as shown), channel queues 140, 142, and 144 for transmitting commands (which can include command data) over channels 140, 142, and 144 to physical media 106, 108, and 110, respectively.

Physical media 106, 108, and 110 can be any suitable physical media for storing information (which can include data, programs, and/or any other suitable information that can be stored in a solid-state drive) in some embodiments. For example, the physical media can be NAND devices in some embodiments.

The physical media can include any suitable memory cells, hardware processor(s) (such as a microprocessor, a digital signal processor, a microcontroller, a programmable gate array, etc.), interface controller(s), interface logic, drivers, etc. in some embodiments. While three physical media (106, 108, and 110) are shown in FIG. 1, any suitable number D of physical media (including only one) can be used in some embodiments. Any suitable type of physical media (such as single-level cell (SLC) NAND devices, multilevel cell (MLC) NAND devices, triple-level cell (TLC) NAND devices, quad-level cell (QLC) NAND devices, penta-level cell (PLC) NAND, NAND with suitable levels of cells, 2D NAND devices, 3D NAND devices, NOR flash memory, any other suitable flash technology, phase change memory technology, and/or other any other suitable volatile and/or non-volatile memory storage technology) can be used in some embodiments. Each physical media can have any suitable size in some embodiments. While physical media 106, 108, and 110 can be implemented using NAND devices, the devices can additionally or alternatively use any other suitable storage technology or technologies, such as NOR flash memory or any other suitable flash technology, phase change memory technology, and/or other any other suitable non-volatile memory storage technology.

Channels 112, 114, and 116 can be any suitable mechanism for communicating information between controller 104 and physical media 106, 108, and 110 in some embodiments. For example, the channels can be implemented using conductors (lands) on a circuit board in some embodiments. While three channels (112, 114, and 116) are shown in FIG. 1, any suitable number C of channels can be used in some embodiments.

Random access memory (RAM) 118 can include any suitable type of RAM, such as dynamic RAM, static RAM, etc., in some embodiments. Any suitable number of RAM 118 can be included, and each RAM 118 can have any suitable size, in some embodiments.

Firmware 120 can include any suitable combination of software and hardware in some embodiments. For example, firmware 120 can include software programmed in any suitable programmable read only memory (PROM) in some embodiments. Any suitable number of firmware 120, each having any suitable size, can be used in some embodiments.

Cache 122 can be any suitable device for temporarily storing information (which can include data and programs in some embodiments), in some embodiments. Cache 122 can be implemented using any suitable type of device, such as RAM (e.g., static RAM, dynamic RAM, etc.) in some embodiments. Any suitable number of cache 122, each having any suitable size, can be used in some embodiments.

Host device 124 can be any suitable device that accesses stored information in some embodiments. For example, in some embodiment, host device 124 can be a general-purpose computer, a special-purpose computer, a desktop computer, a laptop computer, a tablet computer, a server, a database, a router, a gateway, a switch, a mobile phone, a communication device, an entertainment system (e.g., an automobile entertainment system, a television, a set-top box, a music player, etc.), a navigation system, etc. While only one host device 124 is shown in FIG. 1, any suitable number of host devices can be included in some embodiments.

In some embodiments, host device 124 can include workers 126, 128, and 130. While three workers (126, 128, and 130) are shown in FIG. 1, any suitable number of workers W can be included in some embodiments. In some embodiments, at least two workers can be included. A worker can be any suitable hardware and/or software that reads and/or writes data from and/or to solid-state drive 102.

Bus 132 can be any suitable bus for communicating information (which can include data and/or programs in some embodiments), in some embodiments. For example, in some embodiments, bus 132 can be a PCIE bus, a SATA bus, or any other suitable bus.

As described above, in accordance with some embodiments, a workload type can be determined by a machine learning classifier. In order for a machine learning classifier to determining a workload type, the machine learning classifier can be trained to do so and/or be configured to do so based on another machine learning classifier that was trained to do so.

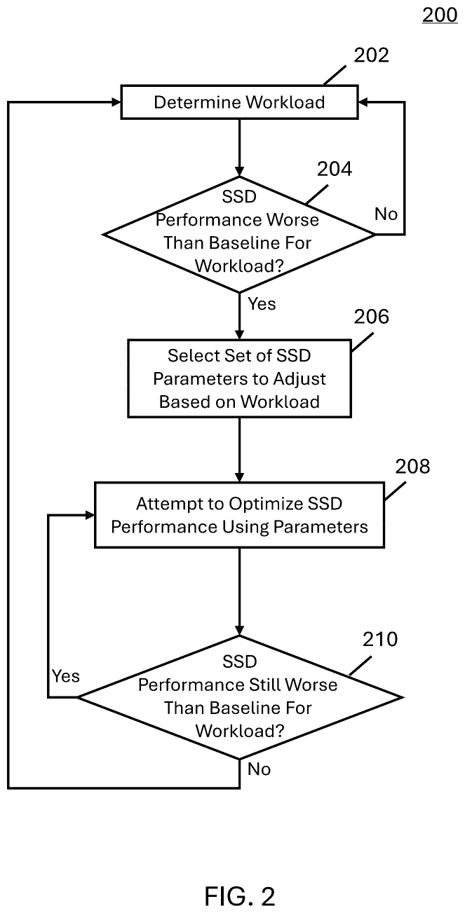

Turning to FIG. 2, a flow diagram of an example process 200 for controlling optimization of SSD parameters in accordance with some embodiments is illustrated. Process 200 can be executed by controller 104 of FIG. 1, in some embodiments.

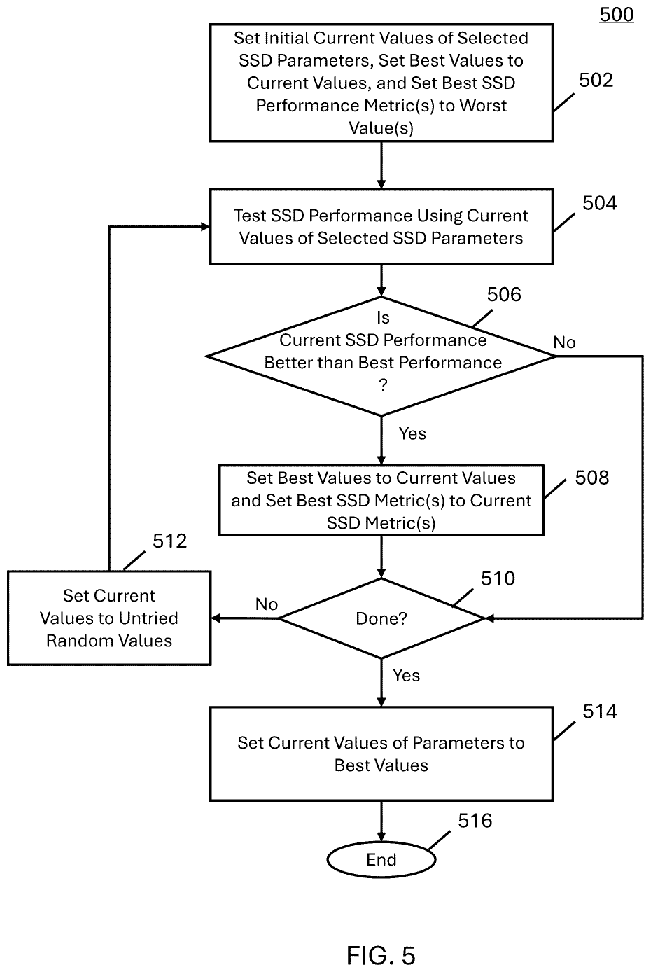

As shown, after process 200 begins, at 202, the process determines a current workload of the SSD. This determination can be made in any suitable manner in some embodiments. For example, this determination can be performed as described below following the description of FIG. 5. As another example, this determination can be made by using heuristics-based algorithms to determine workload characteristics, such as by determining the moving average validity (MAV) value of bands processed for garbage collection, and using this value to identify a workload type typically having this or a similar value. As yet another example, this determination can be made by determining a read/write I/O mix (e.g., 75% read, 25% write), workload queue depth (e.g., queue depth 1 or 128), and I/O size (e.g., 4 Kbytes or 128 Kbytes), and using these values to identify a workload type typically having these or similar values.

Next at 204, the process determines whether the performance of the SSD is worse than a baseline for the current workload. This determination can be made in any suitable manner in some embodiments. For example, in some embodiments, this determination can compare any suitable one or more metrics of the SSD to baseline metric(s) for the current workload. More particularly for example, in some embodiments, process 200 can determine that the performance of the SSD is worse than a baseline for the current workload based on determining that a current input/output operations (IOPs) amount is less than a corresponding baseline value for the determined workload. As another more particular example, in some embodiments, process 200 can additionally or alternatively determine that the performance of the SSD is worse than a baseline for the current workload based on determining that a current average power (AvP) amount is greater than a corresponding baseline value for the determined workload.

If it is determined at 204 that the performance of the SSD is not worse than a baseline for the current workload, then process 200 loops back to 202. Otherwise, process 200 proceeds to 206.

Then at 206, process 200 selects a set of parameters to adjust based on the current workload. Any suitable parameters, and any suitable number of them, can be selected in any suitable manner in some embodiments. For example, in some embodiments, parameters can be selected by identifying (e.g., from a look-up table) parameters having the most impact on SSD performance for a given workload. Example parameters that can be selected in accordance with some embodiments are shown in Table 1 below:

TABLE 1

| Parameter | Impacted Workload |
|---|---|
| SEQ_READ_CMD_CNT | Sequential Reads |
| RND_READ_CMD_CNT | Random Reads |
| PGM_CMD_CNT | Sequential and Random Writes |
| ERASE_CMD_CNT | Sequential and Random Writes |
| GC_BUFF_LIMIT | Random Writes |
| MIXED_GC_BUFF_LIMIT | Mixed Random Reads and Writes |

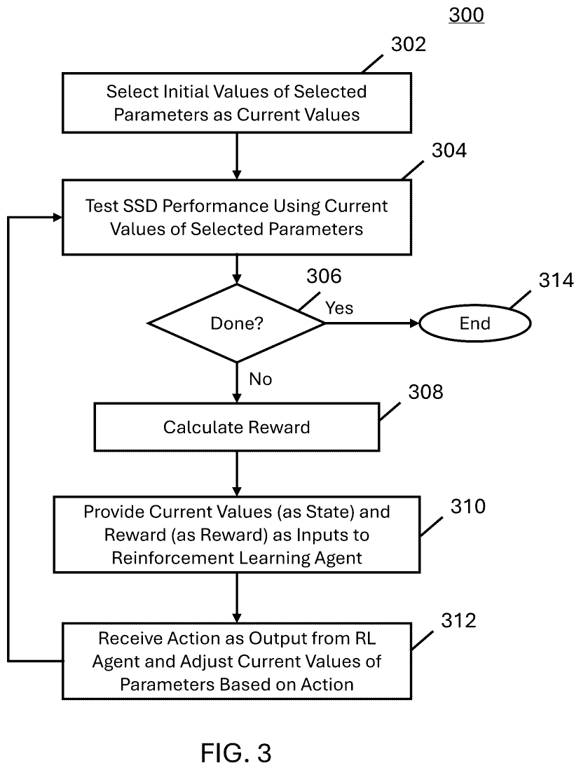

At 208, process 200 next attempts to optimize the performance of the SSD by adjusting one or more of the selected parameters. Process 200 can attempt to optimize the performance of the SSD by adjusting one or more of the selected parameters in any suitable manner, in some embodiments. For example, in some embodiments, process can attempt to optimize the IOPs of the SSD by adjusting the selected parameters. As another example, in some embodiments, process can additionally or alternatively attempt to optimize the AvP of the SSD by adjusting the selected parameters. Examples of processes that can be performed at 208 in accordance with some embodiments are described below in connection with FIGS. 3-5.

Next at 210, process 200 can determine if the performance of the SSD is still worse than the baseline (e.g., the IOPs and/or the AvP of the SSD is still worse than the baseline) for the current workload. This determination can be made in any suitable manner, in some embodiments. For example, in some embodiments, this determination can be made as described above in connect with block 204. If it is determined that the performance of the SSD is still worse than the baseline at 210, then process can loop back to 208. Otherwise, process can loop back to 202.

Turning to FIG. 3, a flow diagram of an example process 300 for optimizing the selected SSD parameters using reinforcement learning (RL) in accordance with some embodiments is illustrated. Any suitable reinforcement learning algorithm can be used by process 300, in some embodiments. Process 300 can be executed by controller 104 of FIG. 1, in some embodiments.

As shown, after process 300 begins, at 302, the process selects initial values of the selected parameters as current values. Any suitable initial values of the selected parameters can be selected in some embodiments. For example, in some embodiments, the initial values can be selected based on previously used values, based on random values, and/or based on predetermined values.

Next at 304, process 300 tests the SDD's performance using the current values (i.e., the initial values selected at 302 when 304 is performed immediately following 302). Process 300 can test the SSD's performance in any suitable manner in some embodiments. For example, in some embodiments, process 300 can execute a portion of the current workload or a test workload corresponding to the current workload and determine the SSD's performance while doing so. As a more particular example, in some embodiments, process 300 can execute a test workload corresponding to the current workload and determine IOPs and/or AvP while doing so.

Then at 306, process 300 determines if it is done optimizing the selected SSD parameters. This determination can be made in any suitable manner in some embodiments. For example, in some embodiments, process 300 can determine that it is done optimizing the selected SSD parameters by checking that power is better than at the start state or (better than at start state and executed at least a given number reinforcement learning cycles (e.g., 250-500).

If it is determined at 306 that process 300 is not done, then the process continues to 308 at which it calculates a reward value based on the determined performance. Any suitable reward function can be used to determine the reward value in some embodiments. For example, in some embodiments, process 300 can use a reward function as follows:

$$reward value = β1 * c 1 + α * IOPs + β2 * ( c 2 + c 3 ) ,$$

where:
β1 is weight for the first component of the reward function and can have any suitable value, such as 0.5, for example;
α is weight for the second component of the reward function and can have any suitable value, such as 0.4, for example;
β2 is weight for the third component of the reward function and can have any suitable values, such as 0.1, for example;

$$c 1 = - {\vert ExP - AvP \vert}^{Y} , if \vert ExP - AvP \vert < Th ;$$

$$c 1 = - M , if \vert ExP - AvP \vert >= Th ;$$

$$c 2 = - 10 * M , when burst power >= kc 2 * ExP ;$$

$$c 2 = 0 , when burst power < kc 2 * ExP ;$$

kc2 is a scaling factor for the c2 threshold and can be set to any suitable value, such as 1.4;

$$c 3 = - 10 * M , when peak power >= kc 3 * ExP ;$$

$$c 3 = 0 , when peak power < kc 3 * ExP ;$$

kc3 is a scaling factor for the c3 threshold and can be set to any suitable value, such as 1.4;
ExP is the expected average power usage of the SSD;
M can be any suitable large value such as 109, for example;
Y can be any suitable real or integer value greater than 1 (e.g., such as 3);
Th is a threshold and can have any suitable threshold amount, such as Exp or approximately Exp (e.g., within 10% of Exp);
AvP is the average power usage of the SSD during the past largest-sized window (e.g., 10,000 μs)
burst power is the average power usage of the SSD during the past middle-sized window (e.g., 500 μs); and
peak power is the average power usage of the SSD during the past smallest-sized window (e.g., 100 μs).

At 310, the process next provides the current values of the selected parameters as a state input and provides the reward value as the reward input to reinforcement learning agent. The current values of the selected parameters and the reward value can be provided in any suitable manner in some embodiments.

Next, process 300 receives an action as output from the RL agent and adjusts current values of selected parameters based on the received action at 312, and then loops back to 304. Process 300 can receive an action as output from the RL agent and can adjust current values of selected parameters based on the received action in any suitable manner in some embodiments. For example, in some embodiments, the action can indicate to increase one or more of the selected parameters, and, in response, process 300 can increment values of the one or more of the selected parameters by a given amount. As another example, in some embodiments, the action can indicate to decrease one or more of the selected parameters, and, in response, process 300 can decrement values of the one or more of the selected parameters by a given amount.

If it is determined at 310 that process 300 is done, then the process can end at 314.

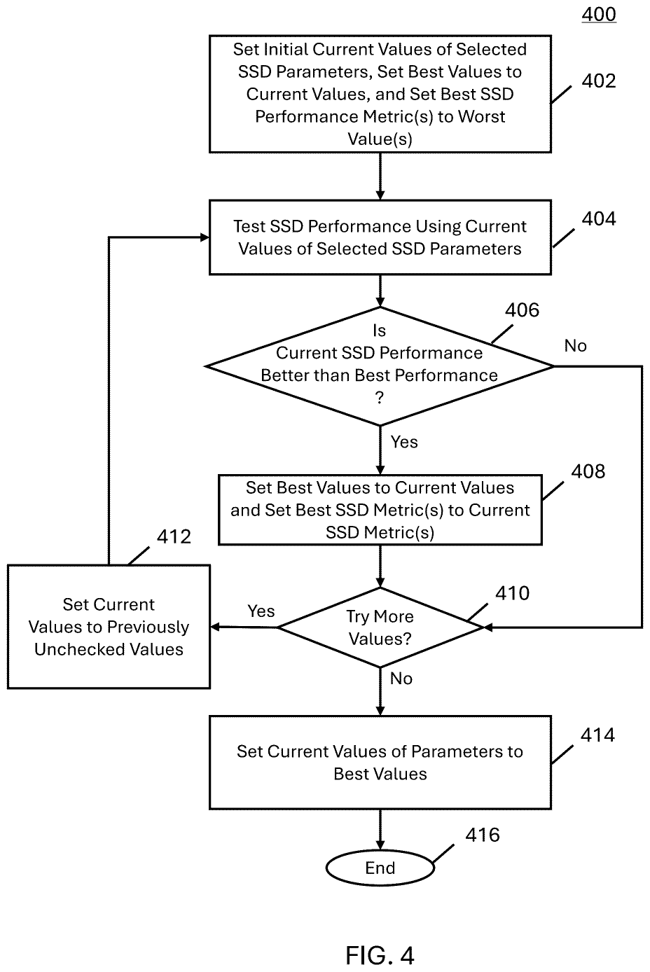

Turning to FIG. 4, a flow diagram of an example process 400 for optimizing SSD parameters using a sweep process in accordance with some embodiments is illustrated. Process 400 can be executed by controller 104 of FIG. 1, in some embodiments.

As shown, after process 400 begins, at 402 the process sets initial current values of the selected parameters, sets best values of the selected parameters to the current values, and sets one or more best SSD performance metrics to worst possible values based on the metrics to be considered. The initial current values of the selected parameters can be selected in any suitable manner, in some embodiments. For example, in some embodiments, the initial current values can be set to the minimum values for each parameter. As another example, in some embodiments, the initial current values can be set to the maximum values for each parameter. As yet another example, in some embodiments, the initial values can be selected based on previously used values, based on random values, and/or based on predetermined values.

Next at 404, process 400 tests the SDD's performance using the current values (i.e., the initial values selected at 402 when 404 is performed immediately following 402). Process 400 can test the SSD's performance in any suitable manner in some embodiments. For example, in some embodiments, process 400 can execute a portion of the current workload or a test workload corresponding to the current workload, and determine one or more current performance metrics while doing so. As a more particular example, in some embodiments, process 400 can execute a test workload corresponding to the current workload and determine IOPs and/or AvP as current SSD metrics while doing so.

Then at 406, process 400 determines whether the current SSD performance is better than the best SSD performance. This determination can be made in any suitable manner, in some embodiments. For example, in some embodiments, this determination can be made by comparing the current performance metric(s) determined at 404 to the best performance metric(s) (which have been set to worst possible values at the first instance of 406). More particularly, for example, if the current metrics are IOPs and AvP, then the performance of the SSD can be considered to be better than the best SSD performance when the IOPs are higher than the best IOPs and when the AvP is lower than the best AvP.

If it is determined that the current SSD performance is better than the best SSD performance, then process 400 can proceed to 408. Otherwise, process 400 can branch to 410.

At 408, the process next sets the best parameter values to the current parameter values and sets the best performance metrics to the current performance metrics. For example, when the current metrics are IOPs and AvP, a best IOP metric can be set to the current IOP metric and a best AvP metric can be set to the current AvP metric.

Next at 410, process 400 determines if more values of the selected parameters are to be tried. If so, process 400 can branch to 412. Otherwise, process 400 can proceed to 414.

At 412, process 400 sets one or more of the current parameter values to previously unchecked values at 412 and loops back to 404. The previously unchecked values can be selected in any suitable manner, in some embodiments. For example, in some embodiments, a next combination of current parameter values can be selected by incrementing one or more of the current value(s) (when the initial current value for each selected parameter was a minimum value) or decrementing one or more of the current value(s) (when the initial current value for each selected parameter was a maximum value). In some embodiments, process 400 can determine to not change one or more of the selected SSD parameters when that/those parameter(s) appear to have reached an optimal value for the given workload. In such case, the one or more of the selected SSD parameters can be held at their best value(s).

After it has been determined at 410 that all possible combinations of values of the selected parameters have been tried, process 400 sets the current values of the selected parameters of the SSD to the best values at 414 and then ends at 416

Turning to FIG. 5, a flow diagram of an example process 500 for optimizing SSD parameters using a Monte Carlo technique is illustrated. Process 500 can be executed by controller 104 of FIG. 1, in some embodiments.

As shown, after process 500 begins, at 502 the process sets initial current values of the selected parameters, sets best values of the selected parameters to the current values, and sets one or more best SSD performance metrics to worst possible values based on the metrics to be considered. The initial current values of the selected parameters can be selected in any suitable manner, in some embodiments. For example, in some embodiments, the initial current values can be set to random values for each parameter. As another example, in some embodiments, the initial values can be selected based on previously used values, based on random values, and/or based on predetermined values.

Next at 504, process 500 tests the SDD's performance using the current values (i.e., the initial values selected at 502 when 504 is performed immediately following 502). Process 500 can test the SSD's performance in any suitable manner in some embodiments. For example, in some embodiments, process 500 can execute a portion of the current workload or a test workload corresponding to the current workload, and determine one or more current performance metrics while doing so. As a more particular example, in some embodiments, process 500 can execute a test workload corresponding to the current workload and determine IOPs and/or AvP as current SSD metrics while doing so.

Then at 506, process 500 determines whether the current SSD performance is better than the best SSD performance. This determination can be made in any suitable manner, in some embodiments. For example, in some embodiments, this determination can be made by comparing the current performance metric(s) determined at 504 to the best performance metric(s) (which have been set to worst possible values at the first instance of 506). More particularly, for example, if the current metrics are IOPs and AvP, then the performance of the SSD can be considered to be better than the best SSD performance when the IOPs are higher than the best IOPs and when the AvP is lower than the best AvP.

If it is determined that the current SSD performance is better than the best SSD performance, then process 500 can proceed to 508. Otherwise, process 500 can branch to 510.

At 508, the process next sets the best parameter values to the current parameter values and sets the best performance metrics to the current performance metrics. For example, when the current metrics are IOPs and AvP, a best IOP metric can be set to the current IOP metric and a best AvP metric can be set to the current AvP metric.

Next at 510, process 500 determines whether the process is done trying different combinations of values of the selected parameters. This determination can be made in any suitable manner. For example, this determination can be made by determining that a given number of combinations of values have been tried or by determining that the performance of the SSD has not improved after a certain number of tests at 504. If it is determined that the process is not done trying different combinations of values of the selected parameters, process 500 can branch to 512. Otherwise, process 500 can proceed to 514.

Then, process 500 sets the current values of the one or more selected parameters to an untried, randomly (or pseudo-randomly) selected set of parameter values at 512 and loops back to 504. In some embodiments, process 500 can determine to not change one or more of the selected SSD parameters when that/those parameter(s) appear to have reached an optimal value for the given workload. In such case, the one or more of the selected SSD parameters can be held at their best value(s).

After it has been determined at 510 that the process is done trying different combinations of values of the selected parameters, process 500 sets the current values of the selected parameters to the best values at 514 and then ends at 516.

Examples of mechanisms, including systems, methods and media for determining workload types that can be used in accordance with some embodiments are described below. These mechanisms can be used to determine the workload type at 202 of process 200 of FIG. 2, in some embodiments.

In some embodiments, a workload type is determined using a machine learning classifier (hereinafter referred to as a “classifier”). Any suitable type of classifier that is based on machine learning can be used in some embodiments. For example, in some embodiments, a classifier can be implemented using a neural network. As a more particular example, in some embodiments, a classifier can be implemented using a deep neural network. In some embodiments, when the classifier is implemented as a neural network, any suitable activation functions, such as leaky ReLU and sigmoid activation functions, can be used in the neural network. In some embodiments, when the classifier is implemented as a neural network, the neural network can have any suitable number and size of hidden layers, use any suitable learning rate (e.g., 0.001), use any suitable loss function (e.g., a mean square error (MSE) loss function), be trained using an adaptive moment estimation (“Adam”) optimizer, and/or use a loss based technique such that when a loss threshold is reached (e.g., <10%) training is stopped to prevent an overfit.

In some embodiments, a classifier used to determine workload types can make this determination based upon any suitable inputs. For example, in some embodiments, a classifier used to determine a workload type of a workload can make this determination based upon a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable inputs.

In some embodiments, a classifier used to determine workload types can produce any suitable outputs. For example, in some embodiments, a classifier used to determine workload types can produce outputs including an indicator that indicates whether the workload is in a steady state, a type of workload that is currently being presented, for each of a plurality of workload types, a likelihood that the current workload is of that workload type, and/or any other suitable outputs.

In order for a machine learning classifier to determining a workload type, the machine learning classifier can be trained to do so and/or be configured to do so based on another machine learning classifier that was trained to do so.

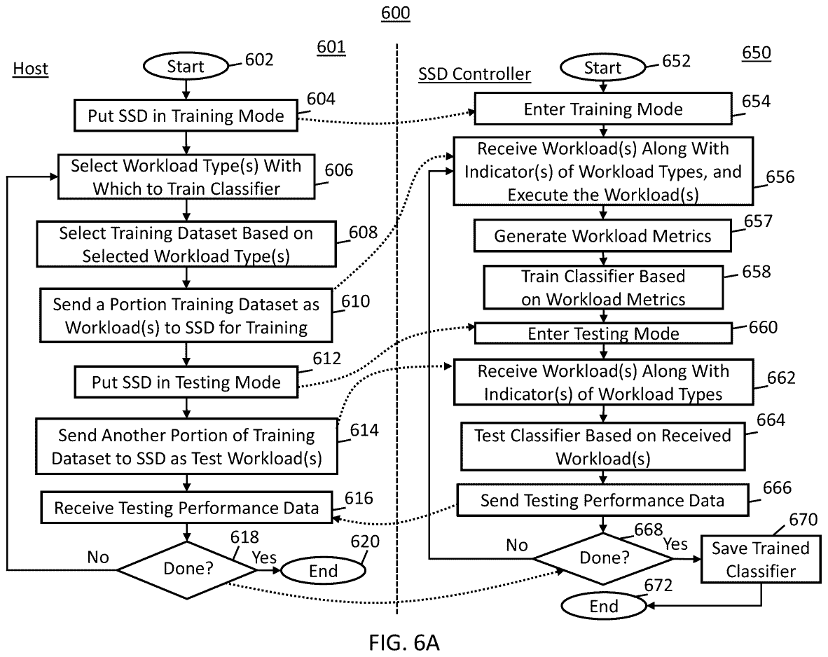

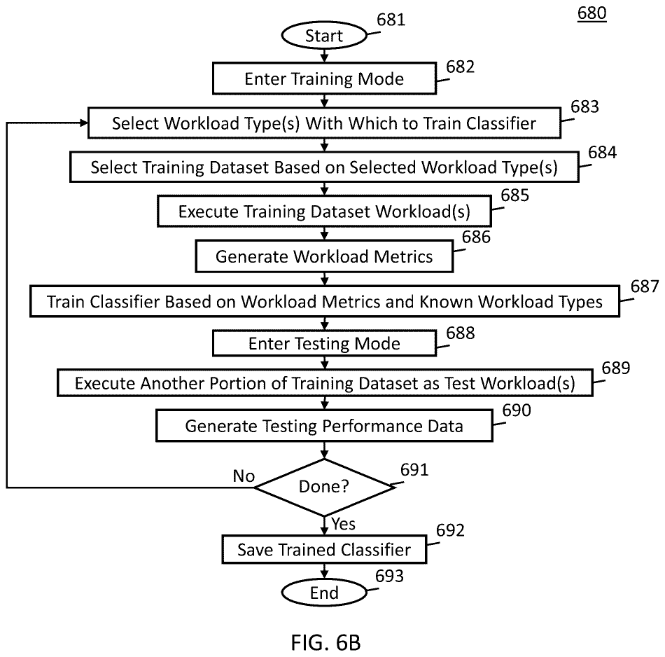

Turning to FIG. 6A, an example 600 of a process for training a machine learning classifier that can be used to determine a workload type of an SSD in accordance with some embodiments is illustrated. As shown, process 600 includes a portion 601 that is executed by a host and a portion 650 that is executed by an SSD controller, in some embodiments.

As shown, after process 601 begins at 602, the process puts the SSD in a training mode 604. Putting the SSD in a training mode can be accomplished in any suitable manner in some embodiments. For example, in some embodiments, process 601 can send a command to the SSD at 604 to put the SSD in a training mode.

After process 650 begins at 652, and in response to process 601 putting the SSD into a training mode, process 650 can enter the training mode at 654. Process can enter the training mode in any suitable manner. For example, in entering the training mode, process 650 can cause a classifier of the SSD to be configured to be trained. As another example, in some embodiments, a classifier can be initialized. More particularly, for example, when implemented with a neural network, the classifier can be initialized with normal Xavier initialization and zero biases.

Next, at 606, process 601 can select one or more workload types upon which the classifier in the SSD is to be trained. Any suitable workload types and suitable number of them can be selected at 606, and the workload types can be selected based on any suitable criteria or criterion. For example, in some embodiments, process 601 can select certain workload types that are applicable to a particular type of the SSD, a particular application for the SSD, a particular industry for which the SSD is intended, one or more particular customers, etc.

Then, at 608, process 601 can select a training dataset based on the selected workload type(s). Any suitable training dataset can be selected in any suitable manner, and the training dataset can have any suitable size. For example, in some embodiments, the training dataset can be selected to have workload examples that correspond to the select workload types.

In some embodiments, the training dataset can have any suitable content. For example, in some embodiments, the training dataset can include workload commands and data as well as indicators that indicate, for each portion of the training dataset, the workload type that corresponds to that portion.

Next, at 610, process 601 can send a portion of the training dataset as one or more workloads to the SSD for training. This portion can be sent in any suitable manner. For example, this portion can be sent in the same manner as a corresponding non-training workload would be sent to the SSD, in some embodiments. More particularly, the portion can be sent to the SSD from the host as a series of commands along with corresponding data (if applicable). In some embodiments, the indicators of the workload type can be sent together with the commands and corresponding data (if applicable), while in other embodiments, the indicators of the workload type can be sent separate from the commands and corresponding data (if applicable).

At 656, process 650 can receive the workload(s) along with the indicator(s) of the workload types, and execute the workload(s).

Process 650 can generate workload metrics at 657. Any suitable workload metrics can be generated in any suitable manner. For example, in some embodiment, generated workload metrics can include a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable metrics.

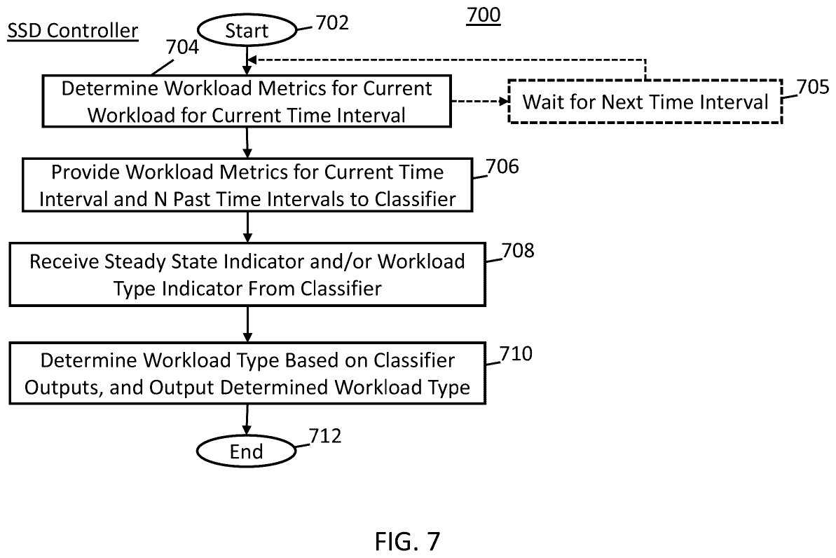

Next, at 658, process 650 can train the classifier using the received workload(s). The classifier can be trained using the received workload(s) in any suitable manner, in some embodiments. For example, in some embodiments, process 650 can provide the classifier with workload metrics from a given number of intervals (as described below in connection with 706 of FIG. 7), receive an output from the classifier, and modify the classifier through backpropagation based on the output and the workload type(s) indicated by the training dataset. In some embodiments, the classifier can be trained using an adaptive moment estimation (“Adam”) optimizer.

After training is complete, at 612, process 601 can put the SSD into a testing mode. Putting the SSD in a testing mode can be accomplished in any suitable manner in some embodiments. For example, in some embodiments, process 601 can send a command to the SSD at 612 to put the SSD in a testing mode.

In response to process 601 putting the SSD into a testing mode, process 650 can enter the testing mode at 660. Process 650 can enter the testing mode in any suitable manner, in some embodiments. For example, in entering the testing mode, process 650 can cause a classifier of the SSD to be configured to evaluate workloads presented to determine their workload types as well as monitor the accuracy of those determinations based on indicators of workload type(s) provided with the workloads.

Next, at 614, process 601 can send another portion of the training dataset to the SSD as test workload(s). This other portion can be sent to the SSD in any suitable manner, in some embodiments. For example, this portion can be sent in the same manner as a corresponding non-training workload would be sent to the SSD, in some embodiments. More particularly, the portion can be sent to the SSD from the host as a series of commands along with corresponding data (if applicable). In some embodiments, the indicators of the workload type can be sent together with the commands and corresponding data (if applicable), while in other embodiments, the indicators of the workload type can be sent separate from the commands and corresponding data (if applicable).

At 662, process 650 can receive the workload(s) along with the indicator(s) of the workload types, and execute the workload(s).

Then, at 664, process 650 can test the trained classifier based on the received workloads. Process 650 can test the trained classifier based on the received workloads in any suitable manner, in some embodiments. For example, in testing the trained classifier, process 650 can evaluate workloads presented to determine their workload types (e.g., as described below in connection with 704, 705, 706, 708, and 712 of FIG. 7) as well as monitor the accuracy of those determinations based on indicators of workload type(s) provided with the workloads, in some embodiments.

Next, at 666, process 650 can send testing performance data to process 601. This performance data can be sent in any suitable manner, in some embodiments. Any suitable performance data can be sent, in some embodiments. For example, in some embodiments, the performance data can include accuracy data.

Process 601 can receive testing performance data at 616.

At 618, process 601 can then determine, based on the performance data and/or any other suitable metric or combination of metrics, whether the classifier has been sufficiently trained. Any suitable performance data can be used to determine whether the classifier has been sufficiently trained, in some embodiments. For example, in some embodiments, process 601 can determine that the classifier has been sufficiently trained when the accuracy of the classifier is within one standard deviation or other statistic distance (e.g., 10%) of the known workload types indicated in the training data.

If process 601 determines at 618 that the classifier has not been sufficiently trained, the process can loop back to 606.

Otherwise, the process can end at 620.

At 668, process 650 can then determine, based on the performance data and/or any other suitable metric or combination of metrics, and/or based on an indicator sent from process 601 at 618, whether the classifier has been sufficiently trained. Any suitable performance data can be used to determine whether the classifier has been sufficiently trained, in some embodiments. For example, in some embodiments, process 601 can determine that the classifier has been sufficiently trained when the accuracy of the classifier is within one standard deviation or other statistic distance (e.g., 10%) of the known workload types indicated in the training data.

If process 650 determines at 668 that the classifier has been sufficiently trained, process 650 can loop back to 656.

Otherwise, the process can save the trained classifier at 670 and then end at 672. The trained classifier can be saved for later use in the present SSD and/or one or more other SSDs separate from the present SSD.

Turning to FIG. 6B, an example 680 of a process for training a machine learning classifier that can be used to determine a workload type in accordance with some embodiments is illustrated. Process 680 can be executed by any suitable computing device, such as a host, in some embodiments.

As shown, after process 680 begins at 681, the process can enter the training mode at 682. Process can enter the training mode in any suitable manner, in some embodiments. For example, in entering the training mode, process 680 can cause a classifier to be configured to be trained. As another example, in some embodiments, a classifier can be initialized. More particularly, for example, when implemented with a neural network, the classifier can be initialized with normal Xavier initialization and zero biases.

Next, at 683, process 680 can select one or more workload types upon which the classifier is to be trained. Any suitable workload types and suitable number of them can be selected at 683, and the workload types can be selected based on any suitable criteria or criterion. For example, in some embodiments, process 680 can select certain workload types that are applicable to a particular type of SSD, a particular application for an SSD, a particular industry for which an SSD is intended, one or more particular customers, etc.

Then, at 684, process 680 can select a training dataset based on the selected workload type(s). Any suitable training dataset can be selected in any suitable manner, and the training dataset can have any suitable size. For example, in some embodiments, the training dataset can be selected to have workload examples that correspond to the select workload types.

In some embodiments, the training dataset can have any suitable content. For example, in some embodiments, the training dataset can include workload commands and data as well as indicators that indicate, for each portion of the training dataset, the workload type that corresponds to that portion.

Next, at 685, process 680 can execute a portion of the training dataset as one or more workloads for training. This portion can be executed in any suitable manner. For example, this portion can be executed in the same manner as a corresponding non-training workload would be executed in an SSD, in some embodiments. As another example, in some embodiments, process 680 can simulate execution of the training dataset as one or more workloads. As yet another example, in some embodiments, when training a classifier for one or more given SSDs, workload metrics/information corresponding to workload executions on one or more other SSDs can be used to simulate the execution of workloads on the one or more given SSDs. This allows SSD classifiers to be trained based on past data from different SSDs and different host configurations.

Process 680 can generate workload metrics at 686. Any suitable workload metrics can be generated in any suitable manner, in some embodiments. For example, in some embodiments, generated workload metrics can include a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable metrics.

Next, at 687, process 680 can train the classifier based on the workload metric(s) and known workload type(s) of the executed workload(s). The classifier can be trained using the received workload(s) in any suitable manner, in some embodiments. For example, in some embodiments, process 680 can provide the classifier with workload metrics from a given number of intervals (as described below in connection with 706 of FIG. 7), receive an output from the classifier, and modify the classifier through backpropagation based on the output and the workload type(s) indicated by the training dataset. In some embodiments, the classifier can be trained using an adaptive moment estimation (“Adam”) optimizer.

After training is complete, at 688, process 680 can enter a testing mode. Process 680 can enter the testing mode in any suitable manner, in some embodiments. For example, in entering the testing mode, process 680 can cause a classifier of the SSD to be configured to evaluate workloads presented to determine their workload types as well as monitor the accuracy of those determinations based on indicators of workload type(s) provided with the workloads.

Next, at 689, process 680 can execute another portion of the training dataset as test workload(s). For example, this other portion can be executed in the same manner as a corresponding non-training workload would be executed in an SSD, in some embodiments. As another example, in some embodiments, process 680 can simulate execution of the training dataset as one or more workloads.

Then, at 690, process 680 can generate testing performance data. This performance data can be generated in any suitable manner, and any suitable performance data can be generated, in some embodiments. For example, in generating the performance data, process 680 can evaluate workloads presented to determine their workload types (e.g., as described below in connection with 704, 705, 706, 708, and 712 of FIG. 7) as well as monitor the accuracy of those determinations based on indicators of workload type(s) provided with the workloads, in some embodiments.

At 691, process 680 can then determine, based on the performance data and/or any other suitable metric or combination of metrics, whether the classifier has been sufficiently trained. Any suitable performance data can be used to determine whether the classifier has been sufficiently trained, in some embodiments. For example, in some embodiments, process 601 can determine that the classifier has been sufficiently trained when the accuracy of the classifier is within one standard deviation or other statistic distance (e.g., 10%) of the known workload types indicated in the training data.

If process 680 determines at 691 that the classifier has not been sufficiently trained, the process can loop back to 683.

Otherwise, the process can save the trained classifier at 692 and then end at 693. The trained classifier can be saved for later use in one or more SSDs.

Turning to FIG. 7, an example 700 of a process for using a machine learning classifier to determine workload types in accordance with some embodiments is illustrated. Process 700 can be executed by an SSD controller, in some embodiments. In some embodiments, process 700 can be performed during 202 of process 200 of FIG. 2.

After process 700 begins at 702, the process can determine current workload metrics for a current workload for a current time interval at 704. Process 700 can determine any suitable current workload metrics in any suitable manner, in some embodiments. For example, in some embodiments, process 700 can determine one or more of a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable inputs. The current time interval can have any suitable duration, in some embodiments. For example, the current time interval can have a duration of a value from 1-25 ms in some embodiments. In some embodiments, as represented by the dashed lines around box 705 and the dashed lines between box 705 and box 704, when process 700 first begins, 704 and 705 (at which process 700 can wait for the next interval) can be repeated over N+1 intervals before proceeding to 706.

Next, at 706, process 700 can provide the workload metrics for the current time interval and N past time intervals as inputs to the classifier. N can have any suitable value, in some embodiments. For example, in some embodiments, N can be two so that workload metrics for three total time intervals are provided to the classifier. These inputs can be provided in any suitable manner, in some embodiments.

Then, at 708, process 700 can receive a steady state indicator, one or more workload type indicators, for each of a plurality of workload type indicators, a likelihood that the current workload is of that workload type, and/or any other suitable output from the classifier. Such output(s) can be received in any suitable manner, in some embodiments.

At 710, process 700 can next determine the workload type based on the steady state indicator, the one or more workload indicators, for each of a plurality of workload type indicators, a likelihood that the current workload is of that workload type, and/or any other suitable outputs of the classifier, and output the determined workload type. This determination can be made in any suitable manner, in some embodiments. For example, in some embodiments, process 700 can determine the workload type by determining which of the indicated output type has the highest likelihood of being the current workload type.

Process 700 can then end at 712.

It should be understood that at least some of the above described blocks of the processes of FIGS. 2-7 can be executed or performed in any order or sequence not limited to the order and sequence shown in and described in the figures. Also, some of the above blocks of the processes of FIGS. 2-7 can be executed or performed substantially simultaneously where appropriate or in parallel to reduce latency and processing times. Additionally or alternatively, some of the above described blocks of the processes of FIGS. 2-7 can be omitted.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for optimizing solid-state drive (SSD) performance, comprising:
memory; and
at least one hardware processor coupled to the memory and collectively configured to at least:
determine a current workload type of an SSD;
select SSD parameters to optimize based on the current workload type;
set current values of the SSD parameters;
test performance of the SSD using the current values of the SSD parameters;
change one or more of the current values of the SSD parameters;
re-test the performance of the SSD after changing the current values; and
set the current values of the SSD parameters to determined best values of the SSD parameters.

2. The system of claim 1, wherein setting the current values of the SSD parameters comprises setting the current values to random values or pseudo-random values.

3. The system of claim 1, wherein testing performance of the SSD using the current values of the SSD parameters is performed using a test workload.

4. The system of claim 1, wherein changing one or more of the current values of the SSD parameters is based on an output of a reinforcement learning agent.

5. The system of claim 4, wherein the output of the reinforcement learning agent is based on a reward function that is based on a measurement of input output operations performed by the SSD during the testing and measurements of an average power, a burst power, and a peak power used by the SSD during the testing.

6. The system of claim 1, wherein changing one or more of the current values of the SSD parameters comprises incrementing or decrementing the current values.

7. The system of claim 1, wherein changing one or more of the current values of the SSD parameters comprises changing the current values to random values or pseudo-random values.

8. A method for optimizing solid-state drive (SSD) performance, comprising:
determining a current workload type of an SSD using a hardware processor;
selecting SSD parameters to optimize based on the current workload type;
setting current values of the SSD parameters;
testing performance of the SSD using the current values of the SSD parameters;
changing one or more of the current values of the SSD parameters;
re-testing the performance of the SSD after changing the current values; and
setting the current values of the SSD parameters to determined best values of the SSD parameters.

9. The method of claim 8, wherein setting the current values of the SSD parameters comprises setting the current values to random values or pseudo-random values.

10. The method of claim 8, wherein testing performance of the SSD using the current values of the SSD parameters is performed using a test workload.

11. The method of claim 8, wherein changing one or more of the current values of the SSD parameters is based on an output of a reinforcement learning agent.

12. The method of claim 11, wherein the output of the reinforcement learning agent is based on a reward function that is based on a measurement of input output operations performed by the SSD during the testing and measurements of an average power, a burst power, and a peak power used by the SSD during the testing.

13. The method of claim 8, wherein changing one or more of the current values of the SSD parameters comprises incrementing or decrementing the current values.

14. The method of claim 8, wherein changing one or more of the current values of the SSD parameters comprises changing the current values to random values or pseudo-random values.

15. A non-transitory computer-readable medium containing computer executable instructions that, when executed by a processor, cause the processor to perform a method for optimizing solid-state drive (SSD) performance, the method comprising:
determining a current workload type of an SSD;
selecting SSD parameters to optimize based on the current workload type;
setting current values of the SSD parameters;
testing performance of the SSD using the current values of the SSD parameters;
changing one or more of the current values of the SSD parameters;
re-testing the performance of the SSD after changing the current values; and
setting the current values of the SSD parameters to determined best values of the SSD parameters.

16. The non-transitory computer-readable medium of claim 15, wherein setting the current values of the SSD parameters comprises setting the current values to random values or pseudo-random values.

17. The non-transitory computer-readable medium of claim 15, wherein testing performance of the SSD using the current values of the SSD parameters is performed using a test workload.

18. The non-transitory computer-readable medium of claim 15, wherein changing one or more of the current values of the SSD parameters is based on an output of a reinforcement learning agent.

19. The non-transitory computer-readable medium of claim 18, wherein the output of the reinforcement learning agent is based on a reward function that is based on a measurement of input output operations performed by the SSD during the testing and measurements of an average power, a burst power, and a peak power used by the SSD during the testing.

20. The non-transitory computer-readable medium of claim 15, wherein changing one or more of the current values of the SSD parameters comprises incrementing or decrementing the current values.
